(19) United States
(12) Patent Application Publication
(10) Pub. No.: US 2009/0164229 A1
(43) Pub. Date: Jun. 25, 2009

(54) SYSTEM AND METHOD FOR MANAGING ADD-ON SALES AT A VEHICLE DEALERSHIP

(75) Inventors: Robert M. Steenbergh, Orlando, FL (US); Phil Battista, South Plainfield, NJ (US)

Correspondence Address: LARSON AND LARSON, 11199 69TH STREET NORTH, LARGO, FL, 33773, US

(73) Assignee: MENUVANTAGE, LLC, Orlando, FL (US)

(21) Appl. No.: 11/963,274

(22) Filed: Dec. 21, 2007

(51) Int. Cl. G06Q 30/00

(52) U.S. Cl. 705/1

(57) ABSTRACT

An application for a system for managing add-ons at a vehicle dealership includes a dealer management computer system for managing processes of a vehicle dealership and an exchange system server interfaced to the dealer management computer system. There are a set of deals stored on the exchange system server, each deal comprising a multiple add-on product offerings. Several providers exist, each provider being associated with at least one of the product offerings. Several terminal computer systems are interfaced to the dealer management computer system for order entry, etc. Software associates one of the deals with a vehicle purchase and separates each deal into component product offerings and for each of the component product offerings, sends a sale confirmation for the component product offering to an associated provider of the plurality of providers.

### BACKGROUND OF THE INVENTION

1. Field of the Invention

This invention relates to the field of vehicle dealership automation and more particularly to a system and method for managing add-on sales in a vehicle dealership.

2. Description of the Related Art

In the automotive dealership environment, a dealer sells multiple add-on products such as GAP, Service Contracts, Etch, Chemicals, etc. Often, these products are obtained from multiple suppliers. These suppliers normally sell their products to the dealer at a cost and the dealer then marks them up and resells them to consumers at the time of a vehicle sale. Currently, at the end of each month, a clerk uses the dealership management system, supplier rate cards and the actual consumer contracts to hand verify that the amounts charged consumers, the cost numbers entered into the dealership management system, and the amounts due for remittance to the suppliers are correct.

In the dealership, a dealer management system track deals, the deals include multiple add-ons, but the dealer management system does not have details on the add-ons and does not have an automated reconciliations and transmission process.

Currently this process is normally performed at the end of the month. At the dealership, someone collects all the contracts, does some error checking and mails the deals to the provider. The provider hand keys the information into their system, checks for errors (approximately 40% have errors), then contacts the dealer and to manually reconcile the differences. This often causes a delay to the consumer. For example, the consumer buys their car on the 1st of the month with a warranty, has a claim on the 10th, but the warranty company doesn't know about the warranty until they get the hard copy at the end of the month. There is no real time transfer of sales data. Errors often occur, especially where the deal depends upon a feature of the vehicle such as the engine type (Turbo, Diesel, etc.).

Presently, a menu system exists that has details on the add-ons but does not allow reconciliation or transmission. In addition, credit aggregation systems are available that collect credit applications and sends the applications to multiple lenders but it does not break down a loan into components before sending to multiple providers.

U.S. Pat. Application 2003/0177133 to Kikida describes a method of managing information regarding vehicles and customers in which information regarding vehicle and customers are stored in a consolidated manner after the vehicle has been sold. It creates a management database based and integrates customer information received from a sales company and vehicle information received from a vehicle manufacturer. This application does not automate the process of data management and reconciliation between auto dealerships and providers of services.

U.S. Pat. Application 2003/0130966 to Thompson et al describes an online data processing system which assists used-car dealers in improving the operational efficiency of their used-car departments. This application does not automate the process of data management and reconciliation between auto dealerships and providers of services.

U.S. Pat. Application 2003/0088436 to Berger describes a system for gathering and managing information about a company's customers and potential customers at the point of customer contact and analyzing the information for service and product selling opportunities. The described system is a sales tool and doesn't automate the process of data management and reconciliation between auto dealerships and providers of services.

U.S. Pat. Application 2002/0103715 to Bennett et al describes a system for communicating information between automotive trading partners. The system allows automotive trading partners to communicate with each other This application does not automate the process of data management and reconciliation between auto dealerships and providers of services.

What is needed is a system that will automate the process of providing add-on products at an automotive dealership.

### SUMMARY OF THE INVENTION

In one embodiment, computer-based method of managing add-ons at a vehicle dealership is disclosed including providing a set of deals to a computer system; each deal comprising a plurality of add-on products. A deal selection related to a vehicle purchase is accepted and stored in the computer system. Later, the deal is divided into the component add-on products and, for each of the component add-on products, a sale confirmation is sent to a provider of that component product.

In another embodiment, a system for managing add-ons at a vehicle dealership is disclosed including a dealer management computer system for managing processes of a vehicle dealership and an exchange system server interfaced to the dealer management computer system. There are a set of deals stored on the exchange system server, each deal comprising one or more add-on product offerings. Several providers exist, each provider being associated with at least one of the product offerings. Also, several terminal computer systems are interfaced to the dealer management computer system for order entry, etc. Software accepts an input associating one of the deals with a vehicle purchase and separates each deal into component add-on product offerings and for each of the component add-on product offerings, the software sends a sale confirmation for the component add-on product offering to an associated provider of the plurality of providers.

In another embodiment, a signal tangibly embodied in a propagation medium comprising at least one instruction configured to implement a system for managing add-ons at a vehicle dealership is disclosed including computer readable instructions for providing a set of deals, each deal including multiple component products. Computer readable instructions are provided for accepting a deal selection related to a vehicle purchase and computer readable instructions are provided for storing the deal selection. Computer readable instructions are also provided for dividing the deal into the component products and for each of the component products, for sending sale confirmations to a provider of the component product.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system of a first embodiment of the prior art.

FIG. 2 illustrates a schematic view of a system of a first embodiment of the present invention.

FIG. 3 illustrates a typical set of offerings of the present invention.

FIG. 4 illustrates a typical data entry screen of the present invention.

FIG. 5 illustrates a vehicle purchase flow chart of the present invention.

FIG. 6 illustrates an exemplary exchange flow of the present invention.

FIG. 7 illustrates an exemplary reconciliation flow of the present invention.

FIG. 8 illustrates an exemplary deal transmission flow of the present invention.

FIG. 9 illustrates a typical computer system of the present invention.

FIG. 10 illustrates a typical dealer network with computer systems of the present invention.

FIG. 11 illustrates an exemplary communications manager flow of the present invention.

FIG. 12 illustrates a typical dealer network with software interactions between computer systems of the present invention.

FIG. 13 illustrates an exemplary communications manager flow of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. Throughout this description, the described system is intended for the management of add-on sales. Although many of the examples shown relate to Finance and Insurance products (F&I), the described system is intended for many different add-on products including, but not limited to, extended service, theft registration, gap insurance, life insurance, disability insurance, under coating, tire protection, tire rims, side lights, tinted windows, stereo systems, CD-changers and fog lights.

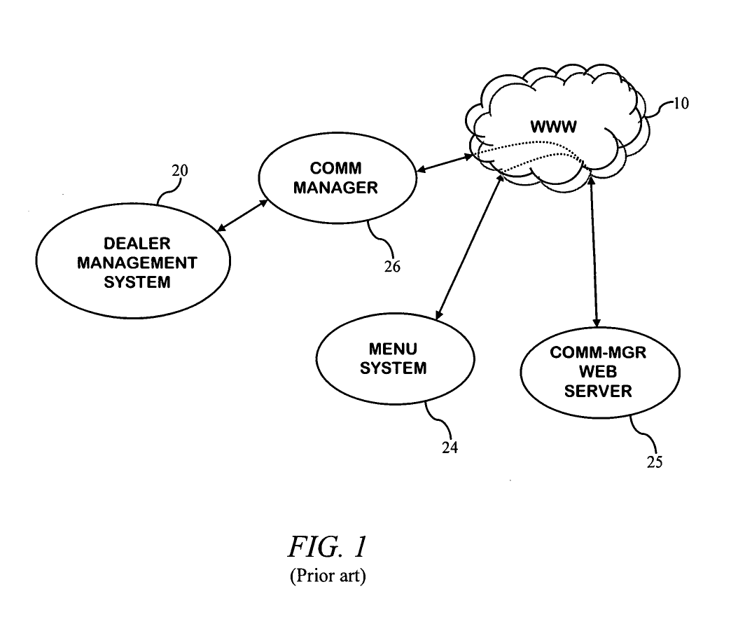

Referring to FIG. 1, a schematic view of a system of a first embodiment of the prior art is shown. In an automobile dealership, there is often a dealer management system (DMS) 20. The dealer management system 20 tracks new and used car inventories, orders, sales, parts, etc. Often, the dealer management system 20 is a proprietary software system with limited access and software options. To get around this, a hardware/software system called a communications manager or Comm Manager 26 was created to provide enhanced communications with other software systems 24/26 through the Internet 10. In some embodiments, the Comm Manager 26 emulates a terminal device to the dealer management system 20 such that the dealer management system 20 believes it is communicating with a networked terminal (PC). The Comm Manager 26 translates this terminal interface into an interface with the Internet 10, providing communications services with web servers 25 and, of particular interest, with a menu system 24. In other embodiments, a surrogate software program operates on the Dealer Management System 20, having access to the Dealer Management files and databases and the surrogate software program communicates directly with the Comm Manager 26.

The menu system 24 provides an improved user interface to the standard displays and forms provided by the dealer management system 20.

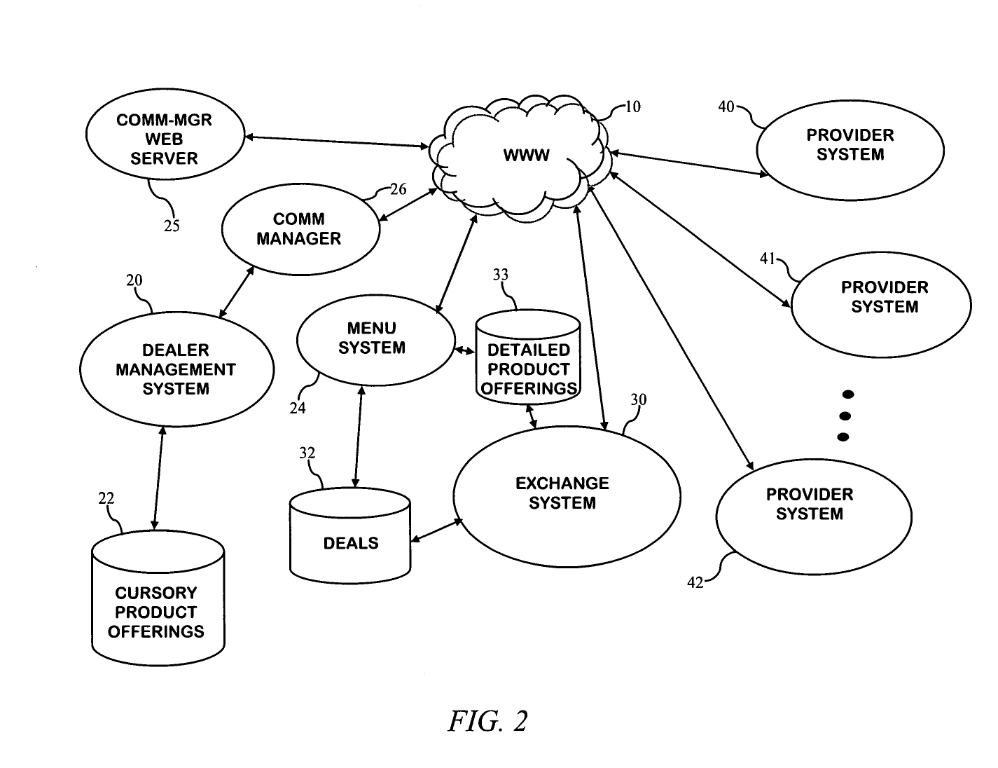

Referring to FIG. 2, a schematic view of a system of a first embodiment of the present invention is shown. As in the prior art (See FIG. 1), the Comm Manager 26 communicates with the dealer management system 20 as described, providing communications services to web servers 25 and, of particular interest, to a menu system 24. The menu system 24 provides an improved user interface to the standard displays and forms provided by the dealer management system 20. In the exemplary system shown, the dealer management system 20 has access to a set of cursory product offerings 22 that can be added to a sale of a vehicle. For example, one product offering includes extended service, theft registration, gap insurance, life insurance, disability insurance, under coating and tire protection while another product offering offers only extended service and tire protection. These cursory product offerings 22 are offered to the car purchaser during the sales transaction. The cursory product offerings 22 contain information and pricing available at the time of their creation. During the reconciliation and checking phase, a web-rating system is used to confirm the actual costs/pricing.

The menu system 24 has access to a detail set of product offerings 33 so that the menu system 24 is capable of presenting these product offerings 33 through its user interface. As customers agree to purchase specific product offerings 33, the selected product offerings 33 are captured in deals 32. Once the deals 32 are checked for accuracy, the exchange system 30 breaks the deals into its constituent parts and exchanges that part of the deal with a provider 40/41/42 associated with that part of the deal. For example, the exchange system 30 will transmit the information regarding the extended warranty to the provider who provides the extended warranty. For example, the exchange system 30 will send details regarding the auto (Vehicle Identification Number or VIN, make, year, color, etc.); details regarding the purchaser (name, address, etc.); and dealer information. It is anticipated that the exchange system 30 will communicate with the provider systems 40/41/42 through any known data communication path including, but not limited to, the Internet 10, dial connections, direct connections, local area networks, etc.

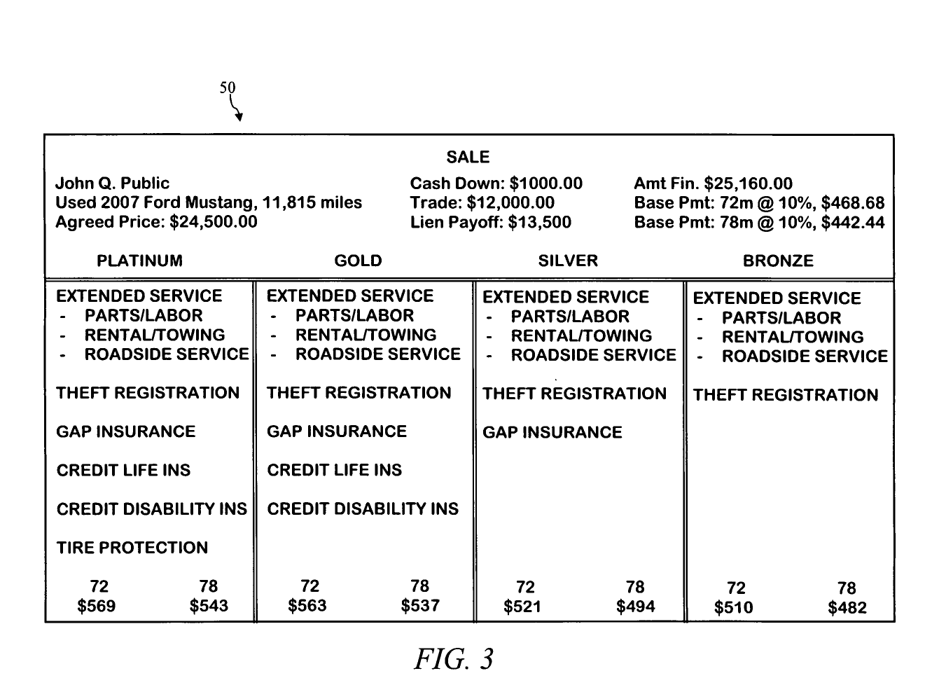

Referring to FIG. 3, a typical set of offerings of the present invention is shown. The chart 50 shows four offerings possible for the Ford Mustang being purchased. The Platinum offering includes extended service, theft registration, gap insurance, credit life insurance, credit disability insurance and tire protection at a cost of $569 for a 72 month loan and $543 for a 78 month loan. The Gold offering includes extended service, theft registration, gap insurance, credit life insurance and credit disability insurance at a cost of $563 for a 72 month loan and $537 for a 78 month loan. The Silver offering includes extended service, theft registration and gap insurance at a cost of $521 for a 72 month loan and $494 for a 78 month loan. The Bronze offering includes extended service and theft registration at a cost of $510 for a 72 month loan and $482 for a 78 month loan. These possible offerings are offered to the customer once the customer decides upon a vehicle.

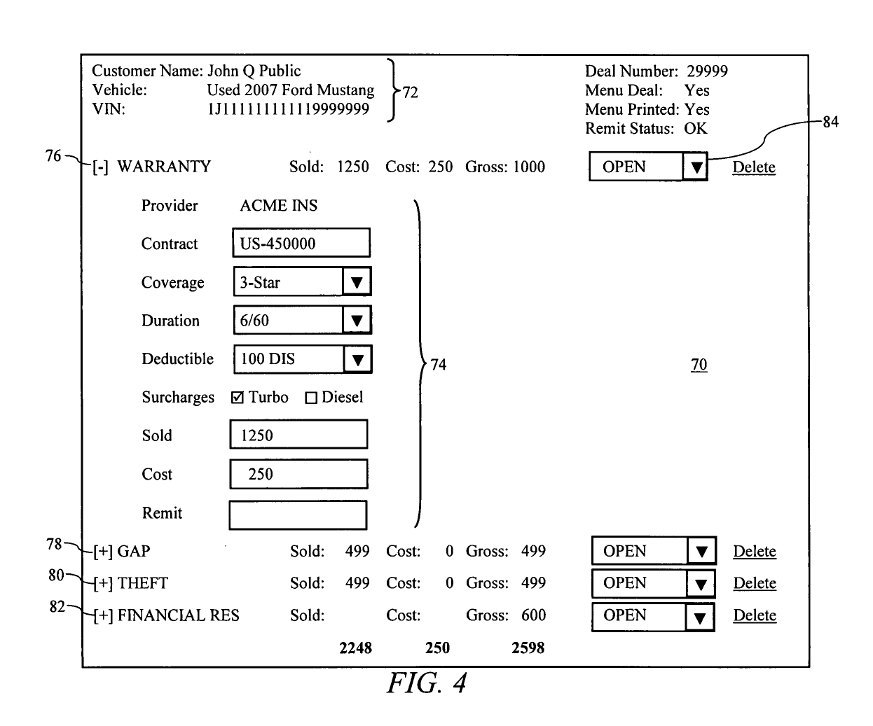

Referring to FIG. 4, a typical data entry screen 70 of the present invention is shown. Once a vehicle purchase is made, vehicle data is extracted from the dealer management system 20 such as the customer name, vehicle description and VIN 72. In the preferred embodiment, this data is extracted by the Comm Manager 26. The sales or finance person who sells the product offering inputs the details regarding the offering 74. Note that the warranty information is shown in an expanded view. Selecting the reduction icon 76 hides this detail information and selecting the expand icons 78/80/82 expands the detail information for the respective portion of the product offer. A status field 84 is provided for each portion of the product offer. Costs and profits are shown for each portion of the product offer. It is anticipated that other similar or different user interfaces are possible and any such user interface is included herewithin.

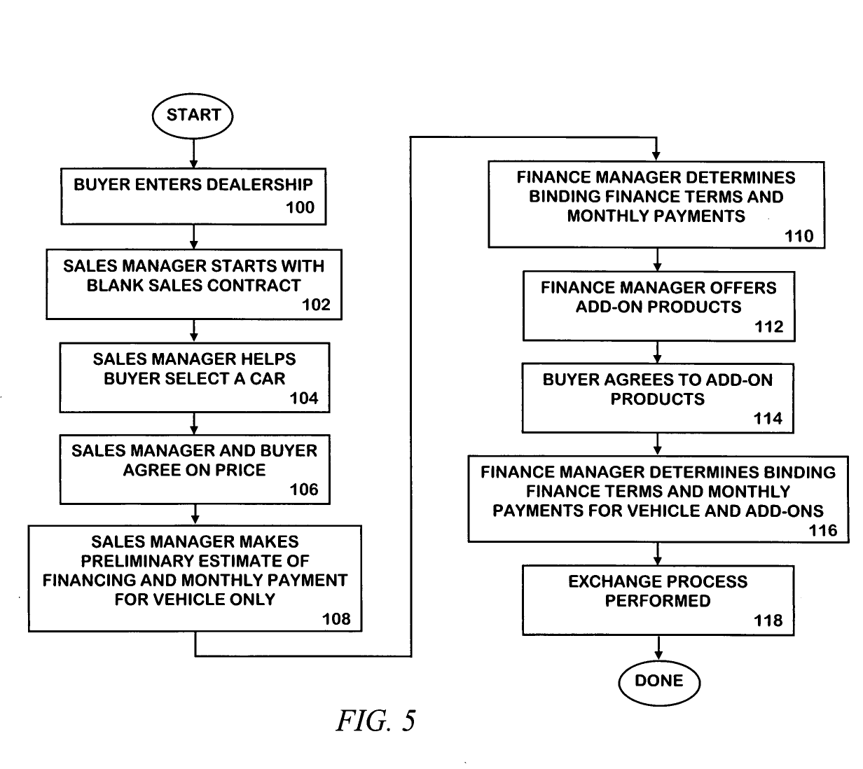

Referring to FIG. 5, a vehicle purchase flow chart of the present invention is shown. This exemplary flow is provided to show a typical process for purchasing a vehicle. Other flows are possible and included herewithin.

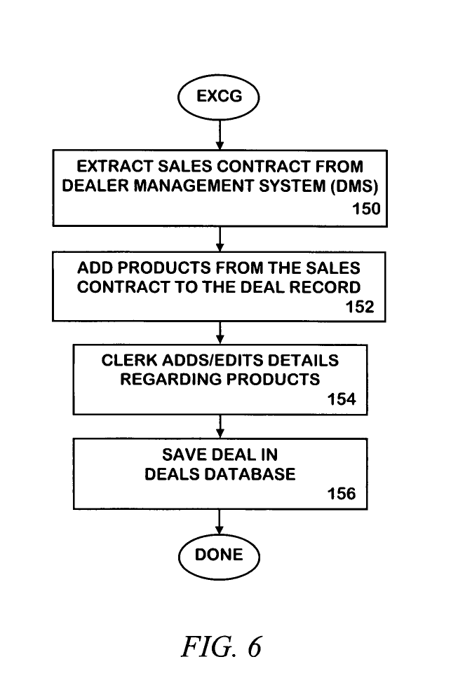

In this example, the process starts with the buyer entering the dealership 100. The sales manager starts with a blank contract or purchase order 102. The sales manager helps the buyer select a vehicle 104 and the buyer and sales manager negotiate the price until they arrive at an agreed upon purchase price 106. At this juncture, the sales manager makes a preliminary estimate of finance charges and monthly payments 108. Now the buyer is passed on to the finance manager where the finance manager determines exact, binding finance terms and monthly payments 110. This is when the finance manager offers the add-on products 112. If the buyer agrees to an add-on product 114, the finance manager recalculates the finance terms and monthly payments to include the add-ons 116 and the exchange process is performed 116 (see FIG. 6). Once agreed to and signed, the deal is deemed sold and the dealership is acting as a surrogate for the provider of the components within the deal. Now, the dealership needs to double check the products sold and communicate the components to the providers.

Referring to FIG. 6, an exemplary exchange flow of the present invention is shown. In this, the sales contract information is extracted 150 from the dealer management system 20 into a deal record. Next, the add-on products are added to the deal record 152 and a clerk adds and/or edits details regarding the products 154 then the deal is saved in the deal database 156.

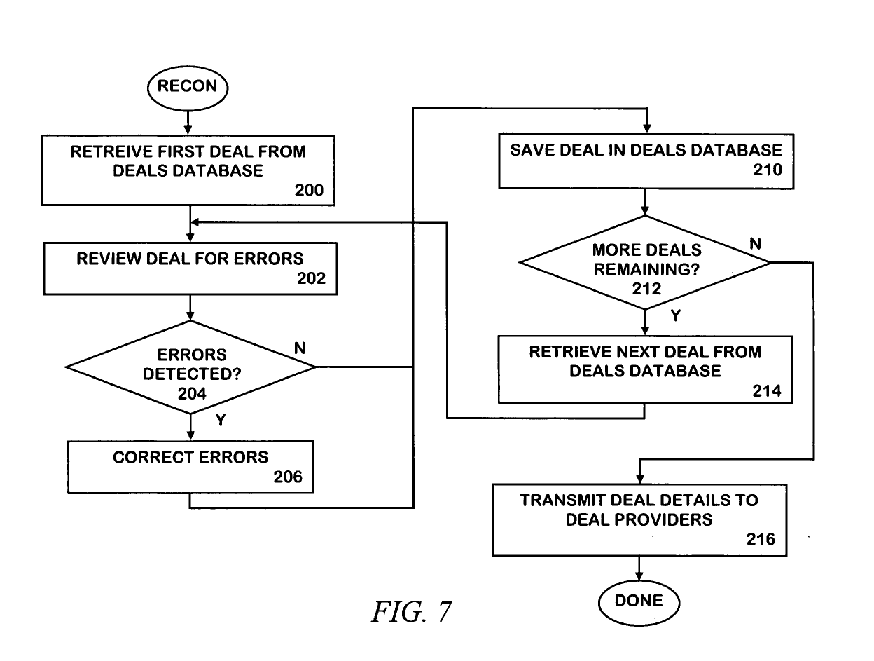

Referring to FIG. 7, an exemplary reconciliation flow of the present invention is shown. This reconciliation process is performed before breaking the deals into individual products and sending them to the product providers. The first deal is retrieved from the deals database 200 and reviewed for errors 202. If errors are detected 204, they are corrected 206 and the deal is saved back into the deals database 210. If more deals remain 212, the next deal is retrieved from the deals database 214 and the above steps are performed for that deal. If no more deals remain 212, the deals are divided into products and transmitted to the deal providers. This is an example of one of many ways known in the industry to divide a deal into its component add-on products.

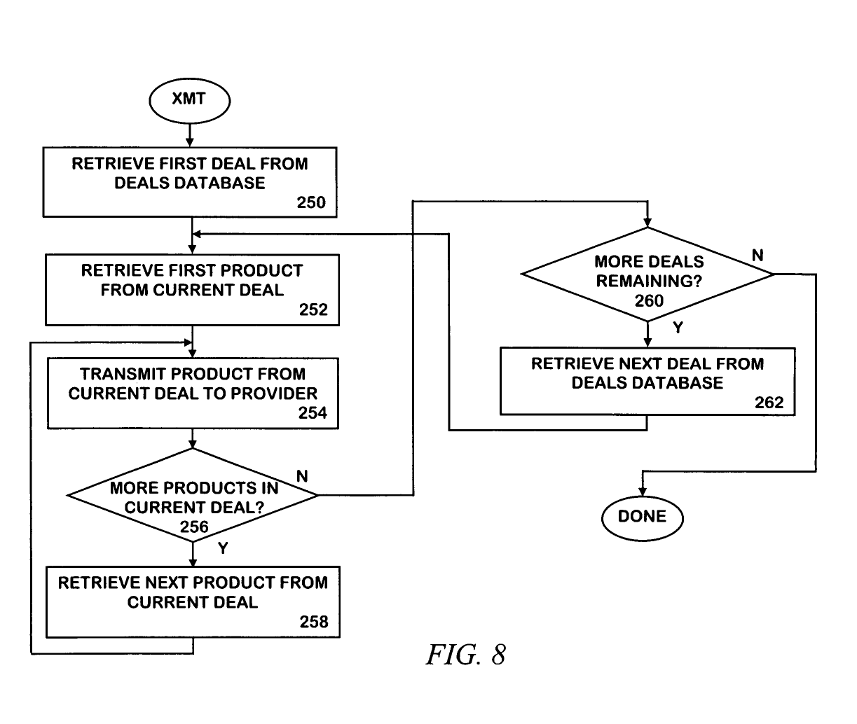

Referring to FIG. 8, an exemplary deal transmission flow of the present invention is shown. The first step is to retrieve the first deal from the deals database 250, then the first product from the deal is retrieved 252 and details of the sale of that product is transmitted to the respective provider 254. If there are more products in the current deal 256, the next product is retrieved from the current deal 258 and the above two steps are repeated until there are no more products in the current deal that haven't been transmitted 256, at which time it is determined if there are more deals remaining 260. If there are more deals remaining 260, the above four steps are repeated to transmit all the products in the remaining deals to the suppliers. If there are no more deals remaining 260, the transmission is finished. Note, that in the preferred embodiment, the details of the sales of the products are transmitted through the Internet 10, while in other embodiments, other communications paths are possible including printed and mailed orders, email, private data communications lines, etc. Note that is well known in the industry to package all products for a given supplier into one transmission and such is included here within.

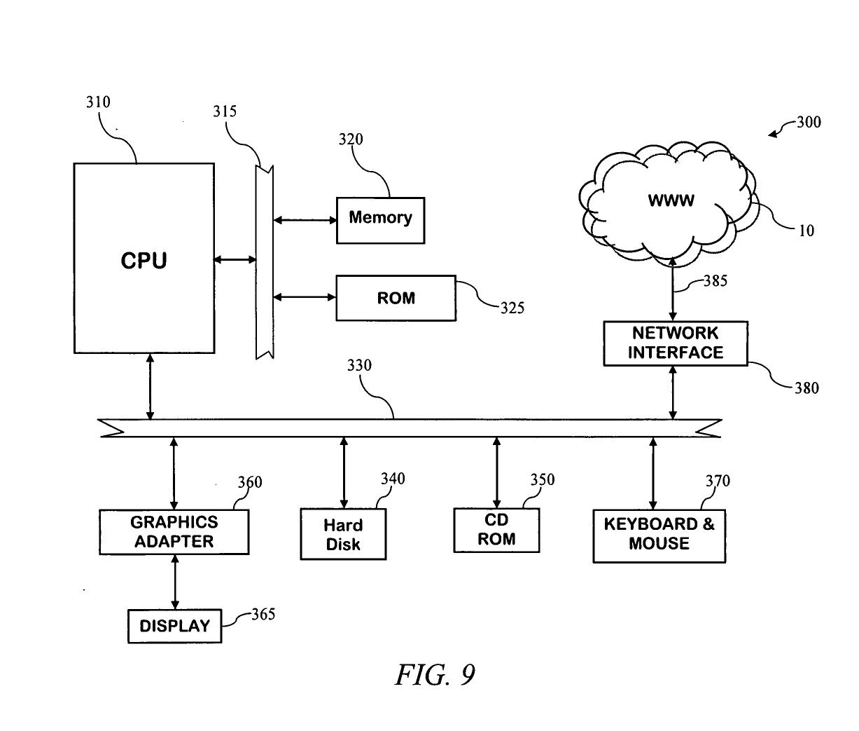

Referring to FIG. 9, a typical computer system of the present invention is shown. In its simplest form, the computer system 300 has a single processor. Many computer architectures are known that accomplish similar results in a similar fashion and the present invention is not limited in any way to any particular computer system. The present invention works well utilizing a single processor system as shown in FIG. 9, a multiple processor system where multiple processors share resources such as memory and storage, a multiple server system where several independent servers operate in parallel (perhaps having shared access to the data or any combination. In the example shown, a processor 310 is provided to execute stored programs that are generally stored for execution within a memory 320. The processor 310 can be any processor or a group of processors, for example an Intel Pentium-4® CPU or the like. The memory 320 is connected to the processor through a memory bus 315. The memory 320 is any memory suitable for connection with the selected processor 310, such as SRAM, DRAM, SDRAM, RDRAM, DDR, DDR-2, etc. Firmware is stored in firmware storage 325 that is connected to the processor 310, also through the memory bus 315 and may include initialization software known as BIOS.

Also connected to the processor 310 is a system bus 330 for connecting to peripheral subsystems such as a network interface 380, a hard disk 340, a CDROM 350, a graphics adapter 360 and a keyboard/mouse 370. The graphics adapter 360 receives commands and display information from the system bus 330 and generates a display image that is displayed on the display 365.

In general, the hard disk 340 may be used to store programs, executable code and data persistently, while the CDROM 350 may be used to load said programs, executable code and data from removable media onto the hard disk 340. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, etc. In some embodiments, other devices are connected to the system through the system bus 330 or with other input-output connections. Examples of these devices include printers, graphics tablets, joysticks, network attached storage (NAS) and communications adapters such as modems and Ethernet adapters.

The network interface 380 connects the computer-based system to other local computer systems and to the world-wide-web 10 through a network interface 380 and a communications link 385 which is, preferably, a high speed link such as a cable broadband connection, a Digital Subscriber Loop (DSL) broadband connection, a T1 line or a T3 line.

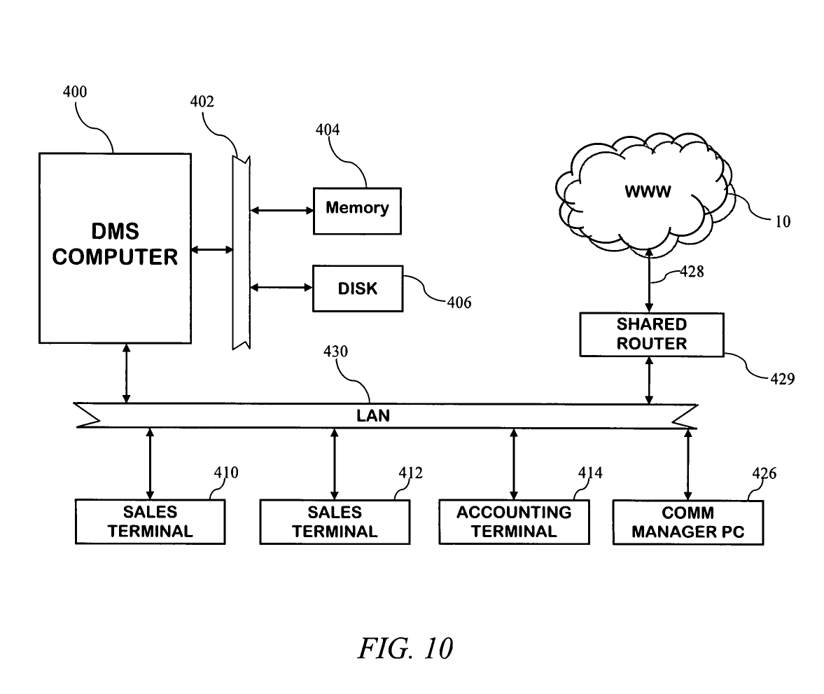

Referring to FIG. 10, a typical dealer network with computer systems of the present invention is shown. The dealer network typically has a central computer or Dealer Management System 400 that has a computer architectures as known in the industry. The dealer management system 20 operates on the DMS processor 400. The DMS processor 400 executes stored programs that are generally stored for execution within a memory 404. The processor 400 can be any processor or a group of processors, for example an Intel Pentium-4® CPU or the like. The memory 404 is connected to the processor through a memory bus 402. The memory 404 is any memory suitable for connection with the selected processor 400, such as SRAM, DRAM, SDRAM, RDRAM, DDR, DDR-2, etc. Firmware is stored in firmware storage 406 that is connected to the processor 400, also through the memory bus 402 and may include initialization software known as BIOS.

The DMS computer system 400 has busses and peripherals as known in the industry, which is not shown for brevity purposes. Typically, the DMS computer system run on a UNIX or UNIX derivative operating system and runs proprietary Dealer Management Software for managing the typical tasks within the dealership. The DMS computer system 400 interfaces with a local area network (LAN) 430 within the automobile dealership and is networked with a plurality of terminal devices such as sales terminals 410/412 and an accounting terminal 414. Other terminals are possible such as a parts department terminal, etc. Although any terminal device is possible, it is preferred that the terminals be a personal computer. The terminal devices 410/412/414 communicate with the DMS computer system 400, displaying information/prompts and accepting user input for transmission to the DMS computer system 400.

Due to the architecture used in the typical Dealer Management Computer System 400, it is difficult to directly network the Dealer Management Computer System 400 to processes running on various systems connected to the Internet. To accomplish this task, a communications manager 426 is connected to the local area network 430. In some embodiments, the communications manager 426 either communicates with a program running on the dealer management server computer 400 while in other embodiments, the communications manager 26 imitates a typical terminal device 410/412/414, thereby communicating with the Dealer Management Computer System 400 without requiring additional or modified Dealer Management Software. In a typical scenario, the communications manager 426 receives a request from the Internet 10 through a communications link 428 and router 429.

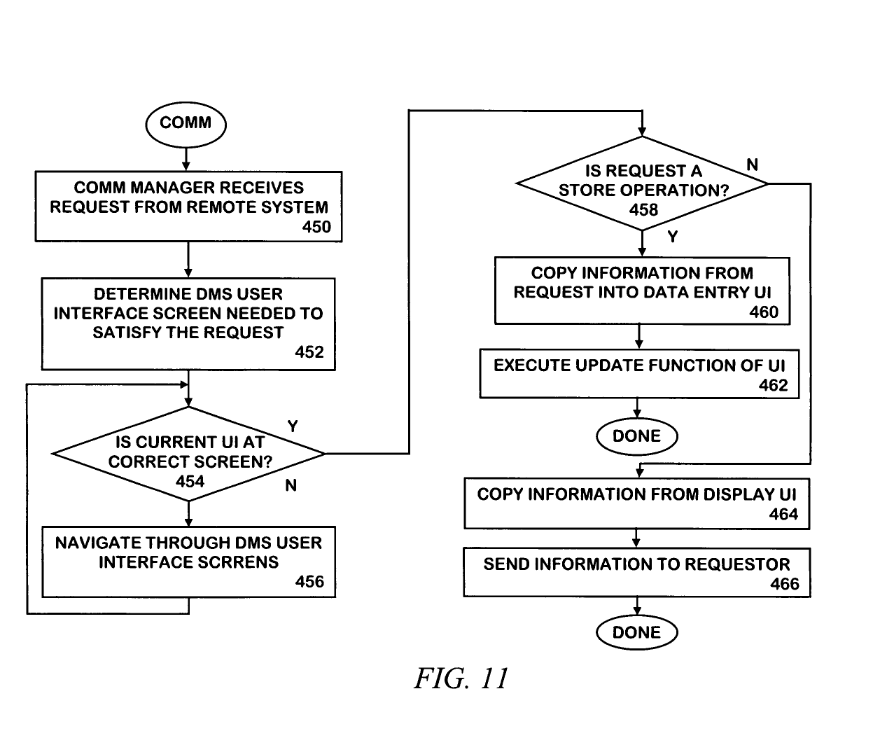

Referring to FIG. 11, an exemplary communications manager flow of the present invention is shown. In this typical scenario, the communications manager 426 receives a request from a remote system 450 (e.g., the Menu System 24). The communications manager 426 determines which DMS user interface screen is needed to satisfy the request 452. If the communications manager 426 is not at that user interface screen 454, the communications manager 426 navigates the Dealer Management Software user interface 456 until it finds the proper user interface screen. Once at the correct user interface screen 454, the communications manager 426 determines if the request is a store operation 458, for example, updating a value in a customer record. If it is a store operation 458, the information from the request is copied to the user interface screen 460 and the update function of the user interface 462 is invoked to accept the data. If it isn't a store operation (e.g., a read operation such as reading a report of a specific deal), the communications manager 426 copies the needed data from the user interface screen 464 and transmits that data back to the requester 466. There are other ways known to imitate a fixed user interface, all of which are included here within.

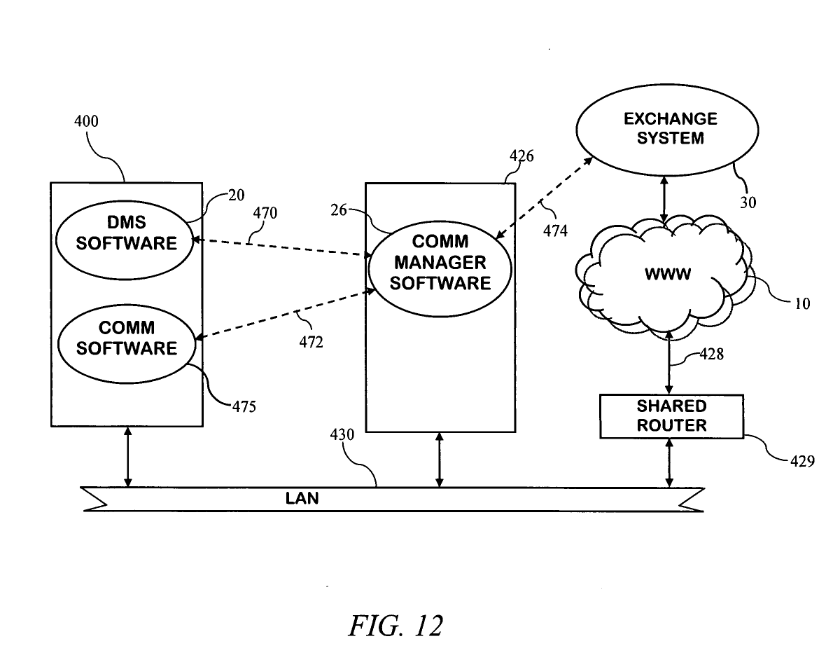

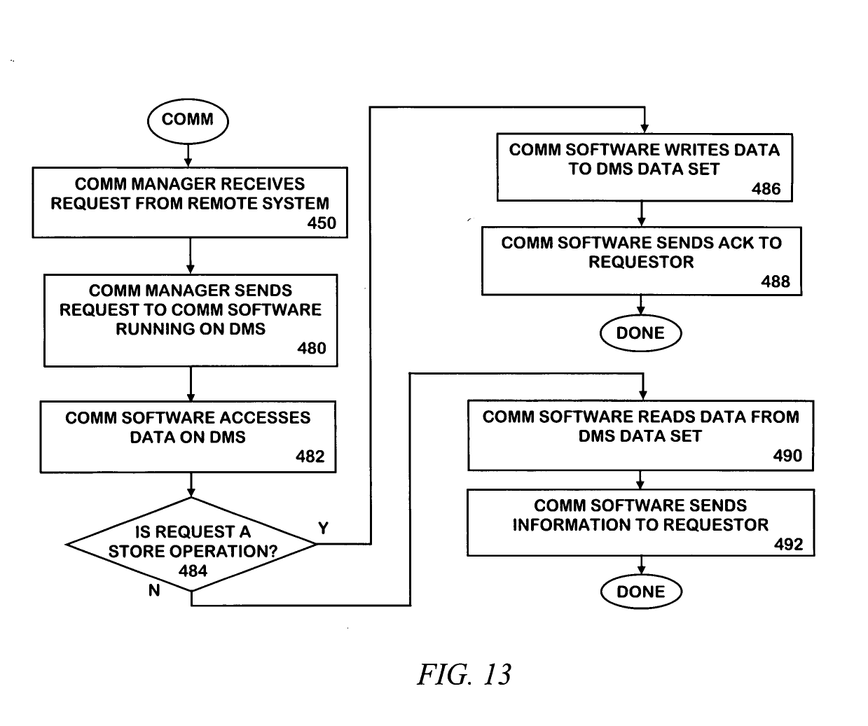

Referring to FIG. 12, a typical dealer network with software interactions between computer systems of the present invention is shown. The dealer network typically has a central computer or Dealer Management System 400. The dealer management software system 20 operates on the DMS processor 400. When the exchange system 30 (for example) needs to communicate with the Dealer Management Software 20, the exchange system 30 communicates with the Comm Manager software 26 through, for example, the internet 10, as depicted by path 474. The Comm Manager 26 then satisfies the request by communicating with the DMS software 20 using the “screen scrape” method as described with FIG. 11 or by communicating with the Comm Software 475 using the communication method as described with FIG. 13.

Referring to FIG. 13, an exemplary communications manager flow of the present invention is shown. In this typical scenario, the communications manager 426 receives a request from a remote system 450 (e.g., the Menu System 24 or Exchange System 30). In some embodiments, the communications manager 426 uses the “screen scrape” method as described with FIG. 11 to log into the Dealer Management System 20 and start the Comm Software 475 running on the Dealer Management system 400. On receipt of the request, the communications manager 426 sends the request to the Comm Software 475 for execution 480. The Comm Manager software 475 then accesses data 482 on the DMS 20. The Comm Software 475 determines if the request is a store operation 484, for example, updating a value in a customer record. If it is a store operation 484, the information from the request is written to the DMS Software 20 data files 486 and acknowledgement is sent to the requester 488. If it isn't a store operation (e.g., a read operation such as reading a database record), the comm. software 475 reads the requested data from the DMS Software 20 data files 490 and sends the data to the requester 492. There are other ways known to read and write data (e.g., interact with) on remote systems, all of which are included here within.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A computer-based method of managing add-ons at a vehicle dealership, the method comprising:
providing a set of deals in a computer system, each deal comprising a plurality of add-on products;
identifying one of the deals related to a vehicle purchase;
storing the one deal in the computer system; and
later, dividing the one deal into component add-on products and for each of the component add-on products, sending a sale confirmation to a provider of the each component add-on product.

2. The computer-based method of managing add-ons at a vehicle dealership of claim 1, wherein the plurality of add-on products is selected from the group consisting of extended service, theft registration, gap insurance, credit life insurance, credit disability insurance, tire protection and under coating.

3. The computer-based method of managing add-ons at a vehicle dealership of claim 1, wherein the vehicle is an automobile.

4. The computer-based method of managing add-ons at a vehicle dealership of claim 1, wherein the computer system is co-located at the vehicle dealership.

5. The computer-based method of managing add-ons at a vehicle dealership of claim 1, wherein the computer system is located remotely from the vehicle dealership and the inputting is performed at a local terminal computer, the local terminal computer connected to the computer system through a network.

6. The computer-based method of managing add-ons at a vehicle dealership of claim 5, wherein the network is an Internet.

7. The computer-based method of managing add-ons at a vehicle dealership of claim 1, wherein the sending of the sale confirmation to the provider of the each component add-on products is performed electronically by sending the sale confirmation from the computer system through a network to a server computer associated with the provider of the each component add-on product.

8. A system for managing add-ons at a vehicle dealership, the system comprising:
a dealer management computer system for managing processes of a vehicle dealership;
an exchange system server interfaced to the dealer management computer system;
a set of deals, each deal comprising a plurality of add-on product offerings, the deals stored on the exchange system server;
a plurality of providers, each provider associated with at least one of the add-on product offerings;
a plurality of terminal computer systems interfaced to the dealer management computer system;
software to associate one of the deals with a vehicle purchase; and
software to separate the one of the deals into component add-on product offerings and for each of the component add-on product offerings, software to send a sale confirmation for the each of the component add-on product offering to an associated provider of the plurality of providers.

9. The system for managing add-ons at a vehicle dealership of claim 8, wherein the exchange server is interfaced to the dealer management system through a communications server, the communications server imitating one of the terminal computer systems interfaced to the dealer management system.

10. The system for managing add-ons at a vehicle dealership of claim 8, wherein the exchange server is interfaced to the dealer management system through a communications server, the communications server communicating with a communications process operating on the dealer management system and having access to dealer management files.

11. The system for managing add-ons at a vehicle dealership of claim 8, wherein the vehicle dealership is an automotive dealership.

12. The system for managing add-ons at a vehicle dealership of claim 8, wherein the plurality of terminal computer systems interfaced to the dealer management computer system by a local area network.

13. The system for managing add-ons at a vehicle dealership of claim 8, wherein the software to separate the one of the deals into component add-on product offerings and the software to send a sale confirmation for the component add-on product offering to an associated provider of the plurality of providers operates on a web server and the web server interfaces to the dealer management system through a network.

14. The system for managing add-ons at a vehicle dealership of claim 13, wherein the network is an Internet.

15. The system for managing add-ons at a vehicle dealership of claim 14, wherein the web server interfaces to the dealer management system through a personal computer, the personal computer adapted to perform communications management functions.

16. The system for managing add-ons at a vehicle dealership of claim 15, wherein the personal computer interfaces to the dealer management system through a local area network and the personal computer imitates a terminal device of the dealer management system.

17. A signal tangibly embodied in a propagation medium comprising at least one instruction configured to implement a system for managing add-ons at a vehicle dealership, wherein the at least one instruction comprises:
computer readable instructions for providing a set of deals, each deal comprising a plurality of add-on products;
computer readable instructions for identifying one of the deals related to a vehicle purchase;
computer readable instructions for storing the one deal; and
later, computer readable instructions for dividing the one deal into component add-on products and for each of the component add-on products, computer readable instructions for sending a sale confirmation to a provider of the each component add-on product.

18. The computer-based method of managing add-ons at a vehicle dealership of claim 17, wherein the plurality of add-on products is selected from the group consisting of extended service, theft registration, gap insurance, credit life insurance, credit disability insurance, tire protection and under coating.

19. The signal tangibly embodied in a propagation medium comprising at least one instruction configured to implement a system for managing add-ons at a vehicle dealership of claim 16, wherein the vehicle is an automobile.

20. The signal tangibly embodied in a propagation medium comprising at least one instruction configured to implement a system for managing add-ons at a vehicle dealership of claim 17, wherein the computer system is co-located at the vehicle dealership.

21. The signal tangibly embodied in a propagation medium comprising at least one instruction configured to implement a system for managing add-ons at a vehicle dealership of claim 17, wherein the computer system is located remotely from the vehicle dealership and the inputting is performed at a local terminal computer, the local terminal computer connected to the computer system through a network.

22. The signal tangibly embodied in a propagation medium comprising at least one instruction configured to implement a system for managing add-ons at a vehicle dealership of claim 21, wherein the network is an Internet.

23. The signal tangibly embodied in a propagation medium comprising at least one instruction configured to implement a system for managing add-ons at a vehicle dealership of claim 22, wherein the computer readable instructions for sending the sale confirmation to the provider of the each component add-on products includes computer readable instructions for preparing an electronic sale confirmation and computer readable instructions for sending the electronic sale confirmation through a network to a server computer associated with the provider of the component add-on product.

24. The signal tangibly embodied in a propagation medium comprising at least one instruction configured to implement a system for managing add-ons at a vehicle dealership of claim 22, wherein the computer readable instructions for sending the sale confirmation to the provider of the component add-on product includes computer readable instructions for printing a paper sale confirmation, the paper sale confirmation sent to the provider of the component add-on products by mail.
